(19) United States
(12) Patent Application Publication
(10) Pub. No.: US 2023/0367065 A1
(43) Pub. Date: Nov. 16, 2023

(54) SILICON PHOTONICS ELEMENT AND OPTICAL MODULE

(71) Applicant: Shinko Electric Industries Co., LTD., Nagano-ken (JP)

(72) Inventor: Yuji Furuta, Nagano-shi (JP)

(73) Assignee: Shinko Electric Industries Co., LTD., Nagano-ken (JP)

(21) Appl. No.: 18/143,689

(22) Filed: May 5, 2023

(30) Foreign Application Priority Data
May 11, 2022 (JP) 2022-078365

(51) Int. Cl. G02B 6/12

(52) U.S. Cl. CPC G02B 6/12007; G02B 2006/12061; G02B 6/29343

(57) ABSTRACT

A silicon photonics element including an optical element that has no self-luminescent capability, a first optical waveguide that connects the optical element to an outside of the silicon photonics element, a ring resonator optically connected to the first optical waveguide and located proximate to the first optical waveguide, and a second optical waveguide optically connected to the ring resonator and located proximate to the ring resonator. The first optical waveguide includes a first end surface connected to the outside of the silicon photonics element, and the second optical waveguide includes a second end surface connected to the outside of the silicon photonics element.

### CROSS-REFERENCE TO RELATED APPLICATIONS

This application is based upon and claims the benefit of priority from prior Japanese Patent Application No. 2022-078365, filed on May 11, 2022, the entire contents of which are incorporated herein by reference.

### FIELD

The present disclosure relates to a silicon photonics element, an optical module, and a method for manufacturing an optical module.

### BACKGROUND

A known optical module used for optical communication includes two optical components and a self-written optical waveguide that optically connects the two optical components. Japanese Laid-Open Patent Publication No. 2019-74708 describes an example of such an optical module. The two optical components may be an optical fiber and a silicon photonics element, which includes an optical element and a silicon optical waveguide connected to the optical element. In the optical module that includes the self-written optical waveguide, photocuring resin is applied between the silicon photonics element and the optical fiber. A beam of light is emitted toward the photocuring resin from each of the silicon optical waveguide and the optical fiber to form the self-written optical waveguide. The self-written optical waveguide is a transparent polymer obtained by continuously growing and elongating a polymer region in the traveling direction of light while keeping the polymer entrapped in the photocuring resin. The technology for fabricating such a self-written optical waveguide facilitates the fabrication of an axially aligned optical waveguide.

### SUMMARY

When the optical element connected to the silicon optical waveguide has no self-luminescent capability, light is not emitted from the silicon optical waveguide toward the photocuring resin. In such a case, the self-written optical waveguide, which optically connects the silicon optical waveguide and the optical fiber, will not be fabricated. This will hinder optical connection of the silicon optical waveguide and the optical fiber. Such a situation will also occur when optically connecting the silicon photonics element to an optical component other than the optical fiber.

A silicon photonics element in one embodiment includes an optical element that has no self-luminescent capability, a first optical waveguide that connects the optical element to an outside of the silicon photonics element, a ring resonator optically connected to the first optical waveguide and located proximate to the first optical waveguide, and a second optical waveguide optically connected to the ring resonator and located proximate to the ring resonator. The first optical waveguide includes a first end surface connected to the outside of the silicon photonics element, and the second optical waveguide includes a second end surface connected to the outside of the silicon photonics element.

### BRIEF DESCRIPTION OF THE DRAWINGS

The embodiments, together with objects and advantages thereof, may best be understood by reference to the following description of the presently preferred embodiments together with the accompanying drawings in which:

FIG. 1 is a schematic perspective view of a silicon photonics element in accordance with one embodiment;

FIG. 2 is a schematic plan view of the silicon photonics element illustrated in FIG. 1;

FIG. 3 is a schematic side view of the silicon photonics element illustrated in FIG. 1;

FIG. 4 is a schematic side view of the silicon photonics element illustrated in FIG. 1;

FIG. 5 is a chart illustrating the light transmission characteristics of a ring resonator;

FIG. 6 is a schematic diagram illustrating propagation paths of light in the silicon photonics element of FIG. 1;

FIG. 7 is a perspective view of an optical module in accordance with one embodiment;

FIG. 8 is a schematic plan view of the optical module illustrated in FIG. 7;

FIG. 9 is a partially enlarged view of FIG. 8;

FIG. 10 is a schematic side view of the optical module illustrated in FIG. 7;

FIGS. 11 to 16 are schematic plan views illustrating a method for manufacturing the optical module in accordance with one embodiment;

FIG. 17 is a schematic plan view illustrating a modified example of the silicon photonics element;

FIG. 18 is a schematic plan view illustrating another modified example of the silicon photonics element;

FIG. 19 is a schematic diagram illustrating a propagation path of light in the silicon photonics element of FIG. 18; and

FIG. 20 is a schematic plan view illustrating a further modified example of the silicon photonics element.

### DESCRIPTION OF THE EMBODIMENTS

One embodiment will now be described with reference to the drawings.

In the accompanying drawings, elements are illustrated for simplicity and clarity and have not necessarily been drawn to scale. To facilitate understanding, hatching lines may not be illustrated or be replaced by shadings in the cross-sectional views. The X, Y, and Z axes that are orthogonal to one another are indicated in each drawing. In the description hereafter, the direction extending along the X-axis will be referred to as the X-axis direction, the direction extending along the Y-axis will be referred to as the Y-axis direction, and the direction extending along the Z-axis will be referred to as the Z-axis direction. In this specification, a plan view refers to a view of a subject taken in a vertical direction, and a planar shape refers to a shape of a subject as viewed in the vertical direction. In this specification, the term facing will refer to a state in which planes or members face each, completely or partially. Further, in this specification, the term facing will also refer to a situation in which two members are separated from each other in addition to a situation in which two members are in contact with each other.

### Structure of Silicon Photonics Element 10

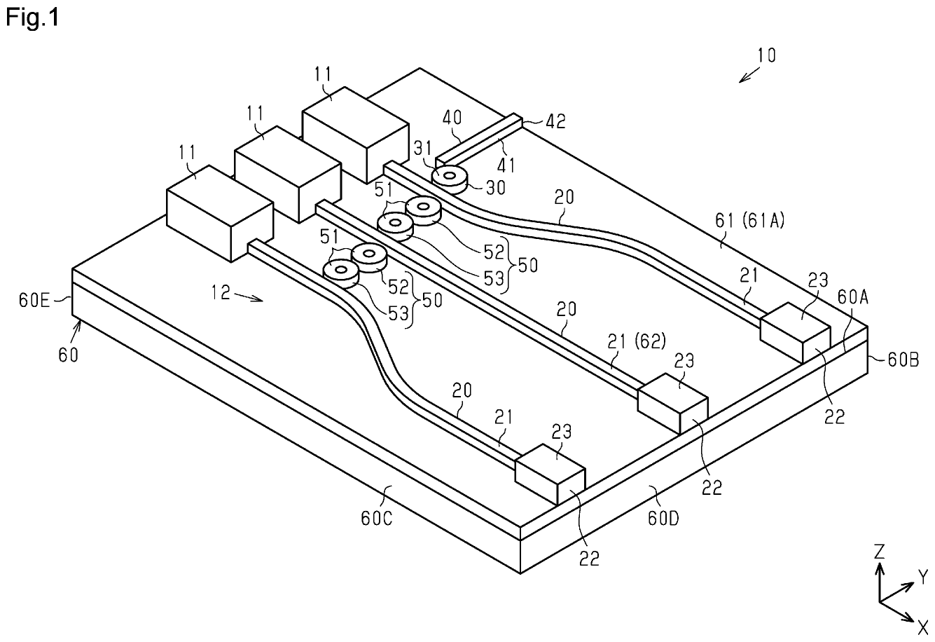

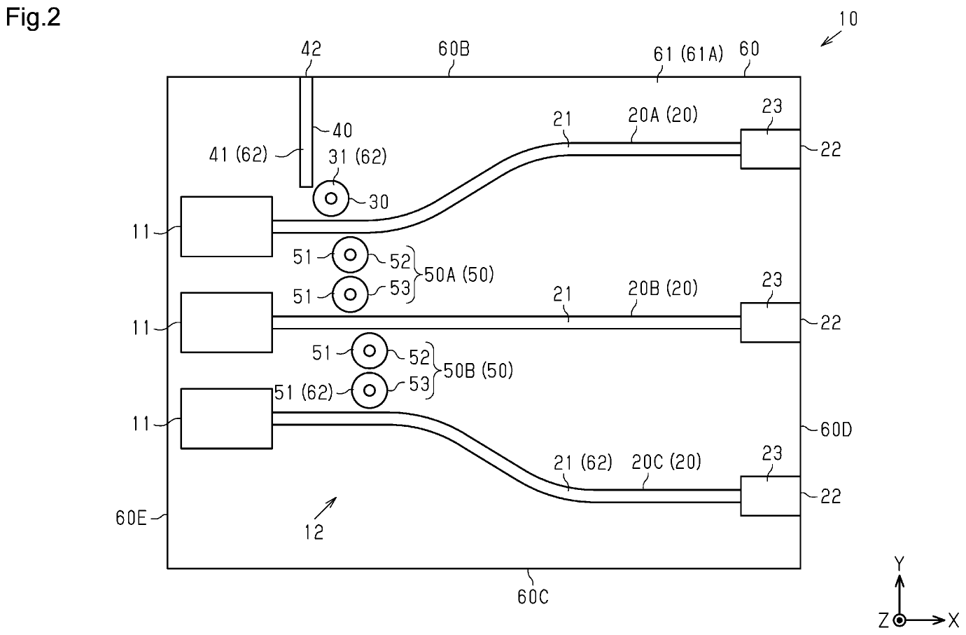

As illustrated in FIGS. 1 and 2, a silicon photonics element 10 includes one or more optical elements 11, having no self-luminescent capability, and optical waveguide circuitry 12, connected to the optical elements 11. The silicon photonics element 10 includes, for example, three optical elements 11. The three optical elements 11 are arranged next to one another in, for example, the Y-axis direction. The three optical elements 11 are spaced apart from one another in the Y-axis direction. The optical elements 11 are not self-luminescent. Each optical element 11 is, for example, a light-receiving element such as a photodiode (PD) or an avalanche photodiode (APD).

As illustrated in FIG. 2, the optical waveguide circuitry 12 includes first optical waveguides 20 optically connected to the optical elements 11, a ring resonator 30 located proximate to one of the first optical waveguides 20, and a second optical waveguide 40 located proximate to the ring resonator 30. In the example of FIG. 2, the optical waveguide circuitry 12 includes three first optical waveguides 20, with each first optical waveguide 20 connected to one of the three optical elements 11. In the description hereafter, the uppermost first optical waveguide 20 in FIG. 2 will be referred to as the first optical waveguide 20A, the middle first optical waveguide 20 in FIG. 2 will be referred to as the first optical waveguide 20B, and the lowermost first optical waveguide 20 in FIG. 2 will be referred to as the first optical waveguide 20C. The optical waveguide circuitry 12 includes double-ring resonators 50, each located, for example, between two adjacent ones of the first optical waveguides 20. In the example of FIG. 2, the optical waveguide circuitry 12 includes two double-ring resonators 50. In the description hereafter, the upper double-ring resonator 50 in FIG. 2 will be referred to as the double-ring resonator 50A, and the lower double-ring resonator 50 in FIG. 2 will be referred to as the double-ring resonator 50B. Each of the first optical waveguides 20, the ring resonator 30, the second optical waveguide 40, and the double-ring resonators 50 is a silicon optical waveguide.

As illustrated in FIG. 1, the optical waveguide circuitry 12 includes, for example, a base 60, a cladding 61, and a core 62.

The base 60 has, for example, the form of a flat plate. The base 60 is, for example, rectangular in plan view. The base 60 includes an upper surface 60A. Further, the base 60 includes end surfaces 60B and 60C, which are the two end surfaces in the Y-axis direction, and end surfaces 60D and 60E, which are the two end surfaces in the X-axis direction. The material of the base 60 may be, for example, silicon (Si).

The cladding 61 is formed on the base 60. The cladding 61 covers, for example, the upper surface 60A of the base 60. The material of the cladding 61 may be, for example, silicon oxide (SiO₂) or the like.

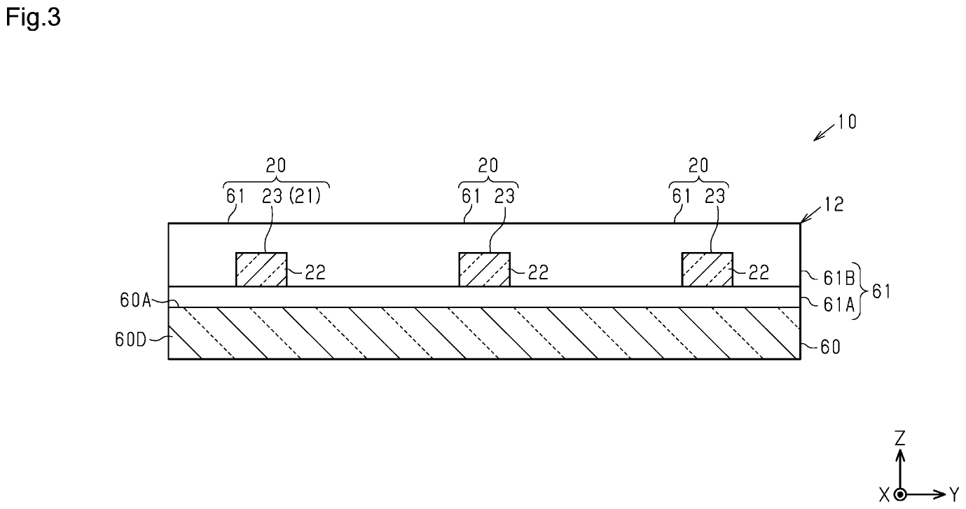

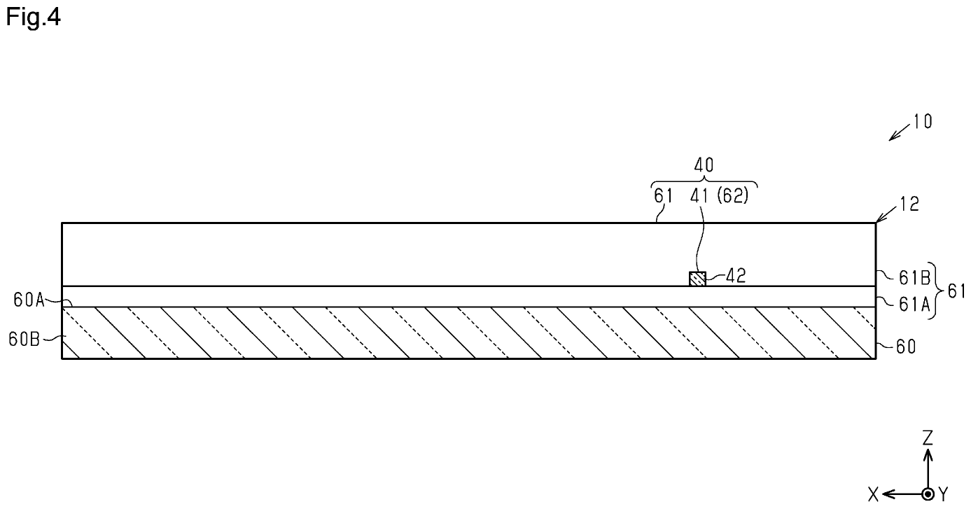

As illustrated in FIGS. 3 and 4, the cladding 61 includes a first cladding layer 61A, formed on the upper surface 60A of the base 60, and a second cladding layer 61B formed on the first cladding layer 61A and covering the core 62. In FIGS. 3 and 4, the boundary of the first cladding layer 61A and the second cladding layer 61B is illustrated by a solid line so that the first cladding layer 61A is distinguished from the second cladding layer 61B in order to aid understanding. In the optical waveguide circuitry 12, however, there may be no boundary between the first cladding layer 61A and the second cladding layer 61B, and the boundary may not be clear. Further, the second cladding layer 61B is not illustrated in FIGS. 1 and 2.

The core 62 is embedded in the cladding 61. The cladding 61 entirely encompasses the core 62. The core 62 is formed on the first cladding layer 61A. The lower surface of the core 62 is entirely covered by the first cladding layer 61A. The side surfaces and upper surface of the core 62 are entirely covered by the second cladding layer 61B. The core 62 is arranged, for example, parallel to the upper surface 60A of the base 60. The core 62 is formed from a material having a higher refractive index than the cladding 61, which is formed from SiO₂. The material of the core 62 may be, for example, silicon (Si). The core 62 propagates optical signals. The light entering the core 62 is propagated in a propagation direction that is in accordance with the planar shape of the core 62.

In the example illustrated in FIG. 2, the core 62 includes first cores 21 forming the first optical waveguides 20, a ring core 31 forming the ring resonator 30, and a second core 41 forming the second optical waveguide 40. Further, the core 62 includes two ring cores 51 forming the double-ring resonators 50. The first cores 21, the second core 41, the ring core 31, and the ring cores 51 are spaced apart from one another. The first cores 21, the second core 41, the ring core 31, and the ring cores 51 are formed independently from one another.

### Structure of First Optical Waveguide 20

The first optical waveguides 20 connect the corresponding optical elements 11 to the outside of the silicon photonics element 10. Each first optical waveguide 20 has, for example, an elongated shape. Each first optical waveguide 20 has one longitudinal end optically connected to the corresponding optical element 11 and another longitudinal end connected to the outside of the silicon photonics element 10. Each first optical waveguide 20 extends, for example, from the corresponding optical element 11 to the end surface 60D of the base 60. Each first optical waveguide 20 has a functionality for propagating light received from the outside of the silicon photonics element 10 to the corresponding optical element 11.

The three first optical waveguides 20A, 20B, and 20C are arranged next to one another in, for example, a first direction (Y-axis direction) that intersects the longitudinal direction of the first optical waveguides 20. For example, the first optical waveguides 20A, 20B, and 20C are spaced apart from one another in the Y-axis direction. For example, the first optical waveguides 20A, 20B, and 20C are arranged so that the interval between two adjacent ones the first optical waveguide 20 in the Y-axis direction is wider at positions closer to the end surface 60D than at positions closer to the optical elements 11.

As illustrated in FIG. 3, each first optical waveguide 20 includes, for example, the first core 21 and the cladding 61, which encompasses the first core 21. In each first optical waveguide 20, optical signals are propagated through only the first core 21.

Each first core 21 has an elongated shape. Each first core 21 extends in, for example, the X-axis direction. Each first core 21 extends from the corresponding optical element 11 to the end surface 60D of the base 60. For example, each first core 21 extends from the corresponding optical element 11 to the end surface 60D of the base 60. Each first core 21 includes a first end surface 22 in the longitudinal direction of the first core 21. The first end surface 22 is connected to the outside of the silicon photonics element 10. The first end surface 22 is exposed from, for example, the end surface 60D of the base 60. The first end surface 22 is, for example, flush with the end surface 60D of the base 60. Each first core 21 includes an edge coupling portion 23 at the one of the two longitudinal ends of the first core 21 that is closer to the first end surface 22. The edge coupling portion 23 is larger than other parts of the first core 21. The first end surface 22, for example, corresponds to the longitudinal end of the edge coupling portion 23.

The first core 21, excluding the edge coupling portion 23, may have a thickness, or dimension in the Z-axis direction, of, for example, about 200 nm to 500 nm. The first core 21, excluding the edge coupling portion 23, may have a width, or dimension in the Y-axis direction, of, for example, about 200 nm to 500 nm. The edge coupling portion 23 may have a thickness of, for example, about 2000 nm to 3000 nm. The edge coupling portion 23 may have a width of, for example, about 2000 nm to 3000 nm.

### Structure of Second Optical Waveguide 40

The second optical waveguide 40 is optically connected to the ring resonator 30. The second optical waveguide 40 is optically connected to the outside of the silicon photonics element 10. The second optical waveguide 40 has, for example, an elongated shape. The second optical waveguide 40 extends, for example, in a direction intersecting the longitudinal direction of the first optical waveguides 20. The second optical waveguide 40 extends, for example, from a position proximate to the ring resonator 30 to the end surface 60B of the base 60. The second optical waveguide 40 has, for example, a functionality for propagating light received from the outside of the silicon photonics element 10 to the ring resonator 30.

As illustrated in FIG. 4, the second optical waveguide 40 includes, for example, the second core 41 and the cladding 61, which encompasses the second core 41. In the second optical waveguide 40, optical signals are propagated through only the second core 41.

The second core 41 has an elongated shape. The second core 41 extends, for example, in the first direction, which intersects the longitudinal direction of the first cores 21. In the example of FIG. 2, the second core 41 extends straight in the Y-axis direction. The second core 41 extends from a position proximate to the ring resonator 30 toward the end surface 60B of the base 60. For example, the second core 41 extends from a position proximate to the ring resonator 30 to the end surface 60B of the base 60. The second core 41 includes a second end surface 42 in the longitudinal direction of the second core 41. The second end surface 42 is connected to the outside of the silicon photonics element 10. The second end surface 42 is exposed from, for example, the end surface 60B of the base 60. The second end surface 42 is flush with, for example, the end surface 60B of the base 60.

The second core 41 may have a thickness, or dimension in the Z-axis direction, that is about the same as the thickness of the first core 21. The thickness of the second core 41 may be, for example, about 200 nm to 500 nm. The second core 41 may have a width, or dimension in the X-axis direction, that is, for example, about the same as the width of the first core 21. The width of the second core 41 may be, for example, about 200 nm to 500 nm.

### Structure of Ring Resonator 30

The ring resonator 30 is located proximate to one of the first optical waveguides 20 and optically connected to that first optical waveguide 20. The ring resonator 30 is located proximate to, for example, the outermost (uppermost in FIG. 2) one of the three first optical waveguides 20, or the first optical waveguide 20A in the example of FIG. 2. The ring resonator 30 is located proximate to the second optical waveguide 40 and optically connected to the second optical waveguide 40. In this manner, the ring resonator 30, separated from the first optical waveguide 20A and the second optical waveguide 40, is optically connected (coupled) to the first optical waveguide 20A and the second optical waveguide 40. The ring resonator 30 has, for example, a functionality for propagating light received from the second optical waveguide 40 to the first optical waveguide 20A.

The ring resonator 30 includes, for example, the ring core 31 and the cladding 61, which encompasses the ring core 31. In the ring resonator 30, optical signals are propagated through only the ring core 31.

The ring core 31 has the form of a ring, for example, a round ring. That is, the ring core 31 has, for example, a circular planar shape. The ring core 31 may have a planar shape of an ellipse, an oval, or a rounded rectangle. The ring core 31 may have a thickness that is, for example, about the same as the thickness of the first cores 21 and the second core 41. The thickness of the ring core 31 may be, for example, about 200 nm to 500 nm. The ring core 31 may have a width that is, for example, about the same as the width of the first core 21 and the second core 41. The width of the ring core 31 may be, for example, about 200 nm to 500 nm. The ring core 31 may have a diameter of, for example, about 5 μm to 15 μm.

The ring resonator 30 is a ring-shaped optical waveguide. The ring resonator 30 receives light and generates a transmission spectrum having a given free spectral range. The ring resonator 30 has a cyclic light transmission characteristic with respect to the frequency of light. That is, the ring resonator 30 has a cyclic light transmission characteristic with respect to the wavelength of light.

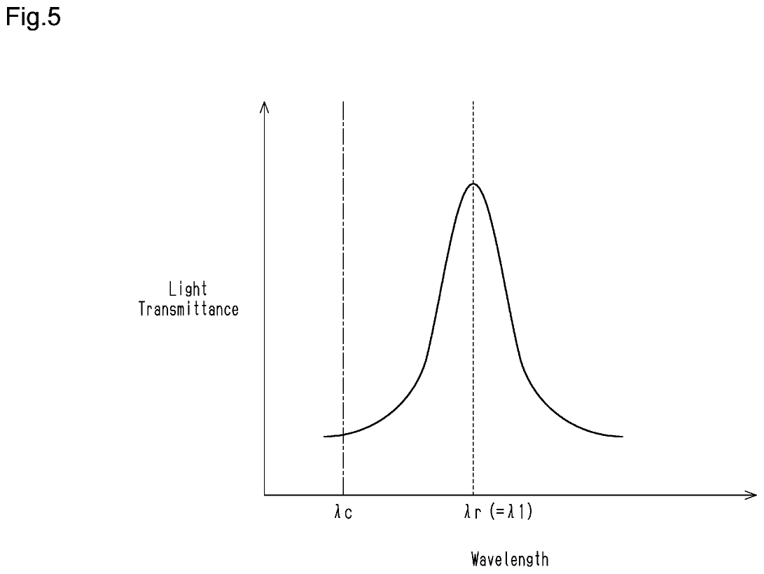

FIG. 5 illustrates the light transmission characteristics of the ring resonator 30. In FIG. 5, the vertical axis represents the light transmittance of the ring resonator 30 and the horizontal axis represents the wavelength of light. As illustrated in FIG. 5, the light transmittance increases as the wavelength of light approaches the resonant wavelength λr. When the wavelength of light is the resonant wavelength λr, the light transmittance reaches its local maximum. The light transmission characteristics of the ring resonator 30 may be adjusted by, for example, the diameter and refractive index of the ring resonator 30 (ring core 31). For example, the diameter of the ring core 31 may be adjusted to adjust the resonant wavelength λr of the ring resonator 30. The resonant wavelength λr of the ring resonator 30 is set to a wavelength that differs from wavelength λc that is used for optical communication by the optical elements 11.

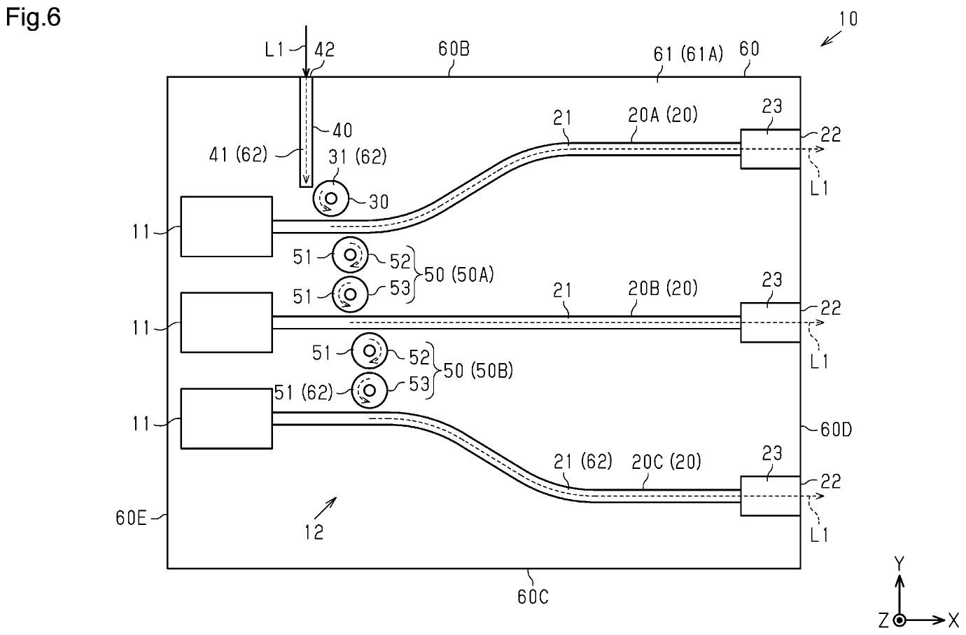

Referring to FIG. 6, when the ring resonator 30 receives light having a given wavelength from the second optical waveguide 40, the ring resonator 30 acts to transmit the light with the transmittance corresponding to the wavelength and propagate the light to the first optical waveguide 20A. For example, when the ring resonator 30 receives light L1 having the resonant wavelength λr of the ring resonator 30 from the second optical waveguide 40, the ring resonator 30 resonates so that the ring resonator 30 propagates the light L1 to the first optical waveguide 20A. Thus, when light L1 having the resonant wavelength λr propagates through the second optical waveguide 40, the light L1 is propagated from the second optical waveguide 40 to the ring resonator 30. Then, the light L1 is propagated through the ring resonator 30 to the first optical waveguide 20A. In other words, when light L1 having the resonant wavelength λr enters the second optical waveguide 40 from the second end surface 42, the ring resonator 30 causes resonation between the second optical waveguide 40 and the first optical waveguide 20A so that the light L1 is emitted from the first optical waveguide 20A.

When the second optical waveguide 40 receives light L1 from the second end surface 42, the ring resonator 30 allows the light L1 to be propagated to the first optical waveguide 20A so that the light L1 is emitted from the first end surface 22. The positional relationship of the ring resonator 30, the first optical waveguide 20A, and the second optical waveguide 40 will now be described in detail.

The ring resonator 30 is located, for example, proximate to a longitudinally middle portion of the first optical waveguide 20A. The ring resonator 30 is, for example, arranged at a position that is proximate to the first optical waveguide 20A and located toward the corresponding optical element 11 in the longitudinal direction of the first optical waveguide 20A. In the ring resonator 30, for example, part of the arc of the ring core 31 faces the first optical waveguide 20A in the first direction (Y-axis direction) that intersects the first optical waveguide 20A. The second optical waveguide 40 is located, for example, between the ring resonator 30 and the optical element 11 in the longitudinal direction of the first optical waveguide 20A. One longitudinal end of the second optical waveguide 40 is located, for example, proximate to an edge portion of the ring resonator 30 that is closest to the optical elements 11. The longitudinal end of the second optical waveguide 40 is located, for example, proximate to the one of the two outermost parts of the ring resonator 30 in the X-axis direction that is closer to the optical elements 11 (left end in FIG. 6). The ring resonator 30 is, for example, separated from the first optical waveguide 20A by a given distance corresponding to the resonant wavelength λr of the ring resonator 30 in order to be optically connectable to the first optical waveguide 20A. The ring resonator 30 is, for example, separated from the second optical waveguide 40 by a given distance corresponding to the resonant wavelength λr of the ring resonator 30 in order to be optically connectable to the second optical waveguide 40.

### Structure of Double-Ring Resonator 50

Each double-ring resonator 50 is located between two adjacent ones of the first optical waveguides 20 in the Y-axis direction. Each double-ring resonator 50 is, for example, arranged between a first optical waveguide 20 that is located at an input side (upper side in FIG. 6) and a first optical waveguide 20 that is located at an output side (lower side in FIG. 6). In the example of FIG. 6, the double-ring resonator 50A is arranged between the first optical waveguide 20A, which is located at the input side, and the first optical waveguide 20B, which is located at the output side. The double-ring resonator 50B is located between the first optical waveguide 20B, which is located at the input side, and the first optical waveguide 20C, which is located at the output side. Each double-ring resonator 50 has a functionality for propagating light received from the input side first optical waveguide 20 to the output side first optical waveguide 20. Each double-ring resonator 50 has a functionality for propagating light to the output side first optical waveguide 20 so that the propagation direction of the light propagated to the output side first optical waveguide 20 is the same as the propagation direction of the light propagated to the input side first optical waveguide 20.

Each double-ring resonator 50 includes two ring resonators 52 and 53. The two ring resonators 52 and 53 are arranged next to each other in the Y-axis direction, which is the direction in which two first optical waveguides 20 are arranged next to each other. The ring resonator 52 is, for example, arranged at a position closer to the ring resonator 30 than the ring resonator 53. The ring resonators 52 and 53 have, for example, the same structure as the ring resonator 30. The ring resonators 52 and 53 have, for example, the same light transmission characteristics as the ring resonator 30. For example, the resonant wavelength of each of the ring resonators 52 and 53 is set to be the same as the resonant wavelength λr of the ring resonator 30. Thus, in the description hereafter, the resonant wavelength of each of the ring resonators 52 and 53 will be referred to as the resonant wavelength λr. Further, the resonant frequency of each of the ring resonators 52 and 53 is set to be the same as the resonant frequency of the ring resonator 30. In this specification, “the same” will not only cover a state in which the compared subjects are exactly the same but also cover a state in which there is a slight difference, resulting from dimensional tolerances or the like, between the compared subjects.

The ring resonators 52 and 53 each include, for example, the ring cores 51 and the cladding 61, which encompasses the ring cores 51. In each of the ring resonators 52 and 53, optical signals are propagated through only the ring cores 51. Each ring core 51 has, for example, the same structure as the ring core 31. Each ring core 51 has, for example, the same size as the ring core 31. Thus, the ring cores 51 will not be described in detail.

Each ring resonator 52 is located proximate to the input side first optical waveguide 20 and optically connected to that first optical waveguide 20. For example, the ring resonator 52 of the double-ring resonator 50A is located proximate to the input side first optical waveguide 20A and optically connected to that first optical waveguide 20A. For example, the ring resonator 52 of the double-ring resonator 50B is located proximate to the input side first optical waveguide 20B and optically connected to the first optical waveguide 20B. Each ring resonator 52 is, for example, separated from the input side first optical waveguide 20 by a given distance corresponding to the resonant wavelength λr of the ring resonator 52 in order to be optically connectable to the first optical waveguide 20.

The ring resonator 52 is located proximate to the ring resonator 53 and optically connected to the ring resonator 53. Each ring resonator 52 is separated from the corresponding ring resonator 53 by a given distance corresponding to the resonant wavelength λr of the ring resonators 52 and 53 so as to be optically connectable to the ring resonator 53.

Each ring resonator 53 is located proximate to the output side first optical waveguide 20 and optically connected to that first optical waveguide 20. For example, the ring resonator 53 of the double-ring resonator 50A is located proximate to the output side first optical waveguide 20B and optically connected to the first optical waveguide 20B. For example, the ring resonator 53 of the double-ring resonator 50B is located proximate to the output side first optical waveguide 20C and optically connected to the first optical waveguide 20C. Each ring resonator 53 is, for example, separated from the output side first optical waveguide 20 by a given distance corresponding to the resonant wavelength λr of the ring resonator 53 in order to be optically connectable to the first optical waveguide 20.

The double-ring resonators 50A and 50B are, for example, arranged at positions closer to the first end surface 22 than the ring resonator 30 in the X-axis direction. The double-ring resonator 50B is, for example, arranged at a position closer to the first end surface 22 than the double-ring resonator 50A in the X-axis direction.

When each double-ring resonator 50 receives light having a given wavelength from the first optical waveguide 20 located at its input side (upper side in FIG. 6), the double-ring resonator 50 acts to transmit the light with the transmittance corresponding to the wavelength and propagate the light to the first optical waveguide 20 located at its output side (lower side in FIG. 6). For example, when the ring resonators 52 and 53 receive light L1 having the resonant wavelength λr of the ring resonators 52 and 53 from the input side first optical waveguide 20, the ring resonators 52 and 53 resonate so that the double-ring resonator 50 propagates the light to the output side first optical waveguide 20.

When the Q-value of the ring resonators 30, 52, and 53 decreases, the transmission characteristics of the ring resonators 30, 52, and 53 become a broad spectrum, and the loss increases in the ring resonators 30, 52, and 53. To increase the Q-value, the ring resonators 30, 52, and 53 undergo an annealing process to decrease the surface roughness of the ring resonators 30, 52, and 53. For example, an annealing process is performed on the ring resonators 30, 52, and 53. The annealing process may be, for example, a hydrogen annealing process.

The propagation path of light L1 in the optical waveguide circuitry 12 when the light L1, which has the resonant wavelength λr of the ring resonators 30, 52, and 53, enters the second optical waveguide 40 from the second end surface 42 will now be described with reference to FIG. 6.

When light L1 having the resonant wavelength λr enters the second optical waveguide 40 from the second end surface 42, the light L1 is propagated through the second optical waveguide 40 toward the ring resonator 30. The light L1 propagated through the second optical waveguide 40 is propagated to the ring resonator 30. The light L1 from the second optical waveguide 40 is propagated counterclockwise in the ring resonator 30. Then, the light L1 is propagated from the ring resonator 30 to the first optical waveguide 20A. The light L1 from the ring resonator 30 is propagated through the first optical waveguide 20A toward the first end surface 22. This emits the light L1 from the first end surface 22 of the first core 21 of the first optical waveguide 20A.

Further, when light L1 is propagated through the first optical waveguide 20A, which is located at the input side of the double-ring resonator 50A, toward the first end surface 22, the light L1 is also propagated to the ring resonator 52 of the double-ring resonator 50A. The light L1 from the first optical waveguide 20A is propagated clockwise in the ring resonator 52. Then, the light L1 is propagated from the ring resonator 52 to the ring resonator 53. The light L1 from the ring resonator 52 is propagated counterclockwise in the ring resonator 53. The light K1 is further propagated from the ring resonator 53 to the first optical waveguide 20B, which is located at the output side. The light from the ring resonator 53 of the double-ring resonator 50A is propagated through the first optical waveguide 20B toward the first end surface 22. This emits the light L1 from the first end surface 22 of the first core 21 of the first optical waveguide 20B.

When the light L1 is propagated through the first optical waveguide 20B, which is located at the input side of the double-ring resonator 50B, toward the first end surface 22, in the same manner as the double-ring resonator 50A, the light L1 is also propagated through the double-ring resonator 50B to the first optical waveguide 20C. The light from the double-ring resonator 50B is propagated through the first optical waveguide 20C toward the first end surface 22. This emits the light L1 from the first end surface 22 of the first core 21 of the first optical waveguide 20C.

In this manner, the ring resonator 30 and the double-ring resonators 50 are arranged so that when the light L1 enters the second end surface 42 of the second optical waveguide 40, the light L1 is emitted from the first end surface 22 of each of the three first optical waveguides 20A, 20B, and 20C.

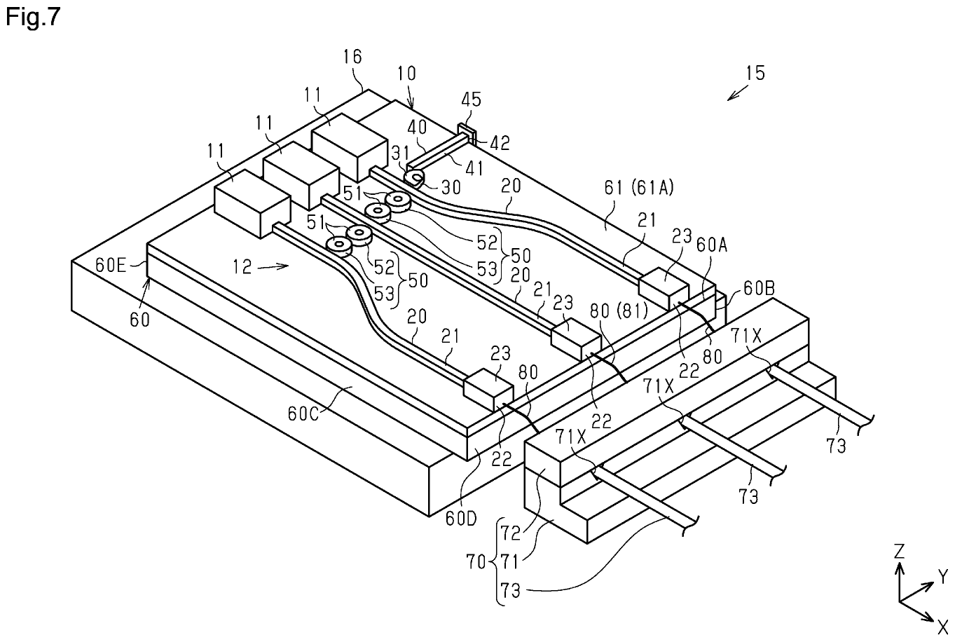

The structure of an optical module 15 will now be described with reference to FIGS. 7 to 10.

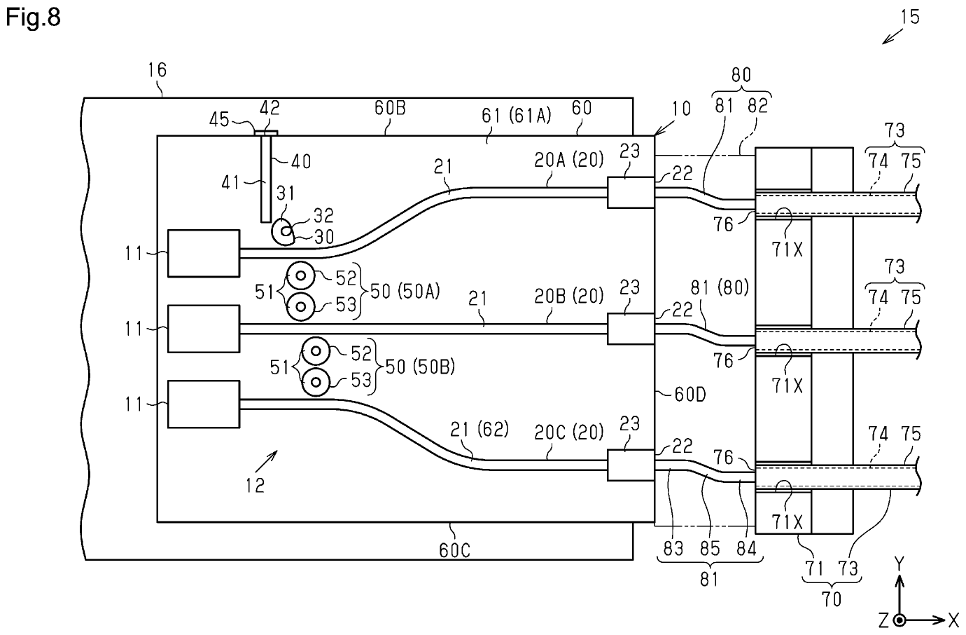

As illustrated in FIGS. 7 and 8, the optical module 15 includes a substrate 16, the silicon photonics element 10, which is mounted on the substrate 16, an optical fiber array 70, and self-written optical waveguides 80. FIGS. 7 and 8 do not illustrate the second cladding layer 61B (refer to FIG. 3) of the silicon photonics element 10.

As illustrated in FIG. 7, the substrate 16 has, for example, the form of a flat plate. The substrate 16 is, for example, rectangular in plan view. The silicon photonics element 10 is mounted on the upper surface of the substrate 16. An optical functional element and an electronic component other than the silicon photonics element 10 may be mounted on the substrate 16. Examples of an optical functional element include a light-emitting element, an optical modulator, an optical amplifier, and an optical attenuator. An optical functional element and an electronic component are, however, not mounted on the substrate 16 in the vicinity of the second end surface 42 of the second optical waveguide 40 in the silicon photonics element 10. The silicon photonics element 10 is mounted on the upper surface of the substrate 16, for example, in a state in which the lower surface of the base 60 is facing the upper surface of the substrate 16. The silicon photonics element 10 is, for example, adhered by an adhesive agent (not illustrated) to the upper surface of the substrate 16.

The optical fiber array 70 includes, for example, a V-groove substrate 71, a cover 72, and multiple (three in this case) optical fibers 73.

The V-groove substrate 71 includes multiple (three in this case) V-grooves 71X. Each V-groove 71X has a V-shaped wall surface. The V-grooves 71X are, for example, spaced apart from one another in the Y-axis direction. The three optical fibers 73 are received in the three V-grooves 71X, respectively. The three optical fibers 73 are, for example, pressed against and fixed to the V-groove substrate 71 by the cover 72. Although not illustrated in the drawings, adhesive agent is applied between the V-groove substrate 71, the cover 72, and the optical fibers 73. The adhesive agent adheres and fixes the V-groove substrate 71, the cover 72, and the optical fibers 73 to one another. This arranges the three optical fibers 73 in place on the V-groove substrate 71.

As illustrated in FIG. 8, each optical fiber 73 includes, for example, a core 74, which propagates optical signals, and a cladding 75, which encompasses the core 74. The core 74 extends, for example, in the longitudinal direction of the optical fiber 73 over the entire length of the optical fiber 73. The core 74 includes a third end surface 76 in the longitudinal direction of the core 74. The cladding 75 extends, for example, in the longitudinal direction of the optical fiber 73 over the entire length of the optical fiber 73. The cover 72 is not illustrated in FIG. 8.

The optical fiber array 70 is arranged facing the first end surface 22 of the silicon photonics element 10. The optical fiber array 70 is separated from the silicon photonics element 10 in the X-axis direction. The optical fiber array 70 is arranged, for example, so that the third end surfaces 76 of the cores 74 of the optical fibers 73 face the first end surfaces 22 of the first cores 21, respectively. In the example of FIG. 8, however, the center axis of each core 74 is shifted away from the center axis of the edge coupling portion 23 of the corresponding first core 21. For example, the center axis of each core 74 is shifted in the Y-axis direction, downward in FIG. 8, from the center axis of the edge coupling portion 23.

Multiple (three in this case) self-written optical waveguides 80 are arranged between the silicon photonics element 10 and the optical fiber array 70. The self-written optical waveguides 80 optically connect the optical fibers 73 and the first optical waveguides 20, respectively. Each self-written optical waveguide 80 optically connects the light input portion of the corresponding optical fiber 73 and the light output portion of the corresponding first optical waveguide 20.

Each self-written optical waveguide 80 includes, for example, a core 81 and a cladding 82 encompassing the core 81. Each core 81 extends from the first end surface 22 of the first core 21 of the corresponding first optical waveguide 20 to the third end surface 76 of the core 74 of the corresponding optical fiber 73. Each core 81 is, for example, bent to absorb the shifting of the center axes of the edge coupling portion 23 and the core 74. Each core 81 includes, for example, a straight portion 83 extending straight in the X-axis direction from the first end surface 22, a straight portion 84 extending straight in the X-axis direction from the third end surface 76, and a bent portion 85 connecting the straight portion 83 and the straight portion 84. Each core 81 is formed by, for example, photocuring a photocuring resin.

The cladding 82, which is not illustrated in detail, entirely encompasses the cores 81. The cladding 82, for example, collectively encompasses the three cores 81. The cladding 82, for example, fills the gap between the silicon photonics element 10 and the optical fiber array 70. The cladding 82 has, for example, a functionality for adhering the silicon photonics element 10 to the optical fiber array 70. The cladding 82 is formed by, for example, photocuring a photocuring resin.

In the optical module 15, the structure of the silicon photonics element 10 is partially changed from the structure of the silicon photonics element 10 illustrated in FIG. 2. The changed parts of the structure will now be described.

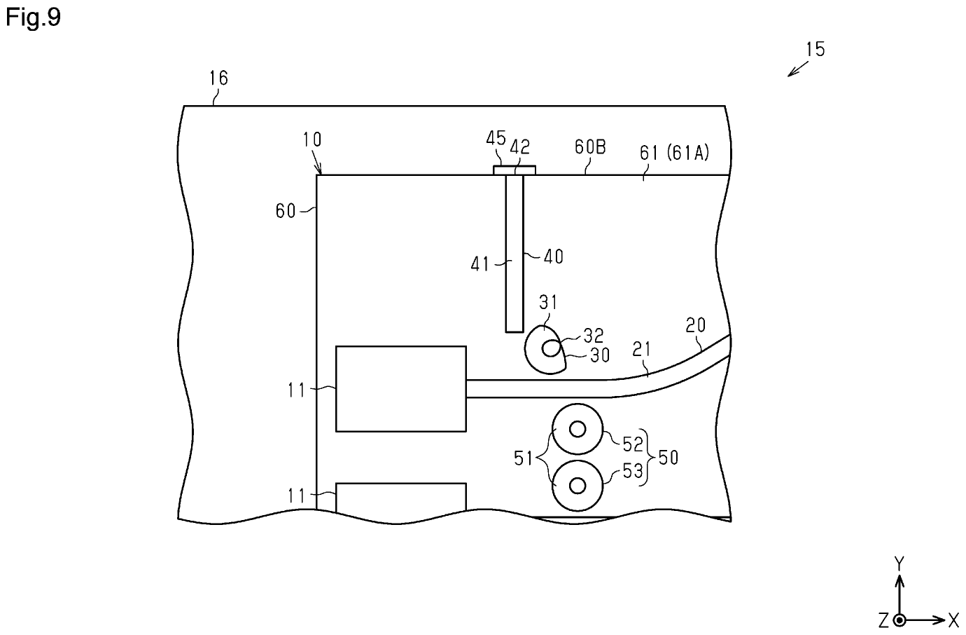

As illustrated in FIG. 9, the ring resonator 30 of the optical module 15 is, for example, at least partially melted. The ring resonator 30 includes, for example, a melted portion 32 formed by partially melting the ring core 31 in the circumferential direction. In the ring resonator 30, for example, the melted portion 32 deforms the ring structure (annular structure) of the ring core 31. Thus, the ring resonator 30 does not have the functionality for propagating light, for example, between the first optical waveguide 20 and the second optical waveguide 40.

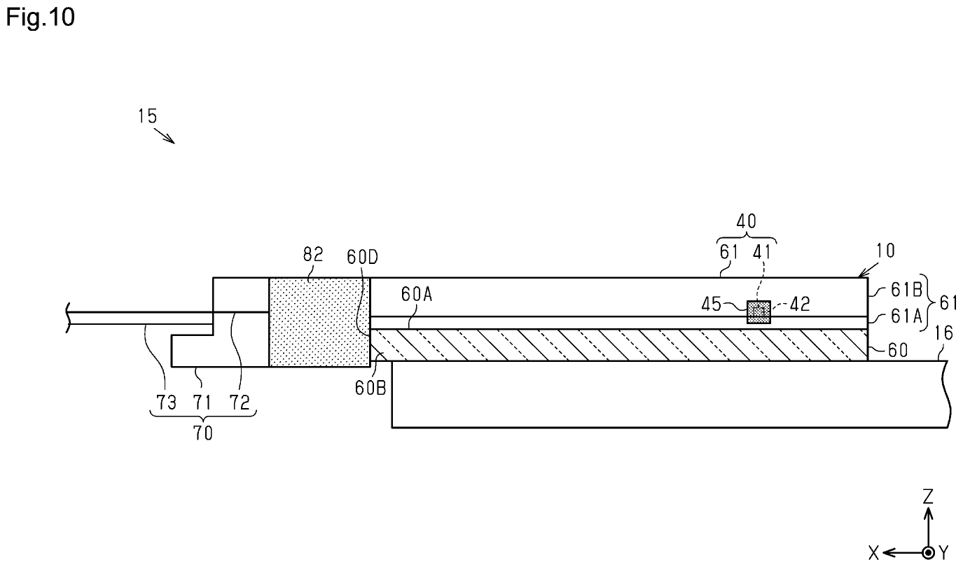

As illustrated in FIGS. 9 and 10, the silicon photonics element 10 in the optical module 15 includes a coating 45 that covers the second end surface 42 of the second core 41 of the second optical waveguide 40. The coating 45 entirely covers the second end surface 42. The coating 45, for example, further covers the end surface of the cladding 61 around the second end surface 42, as illustrated in FIG. 10. The material of the coating 45 may be, for example, a resin material that is not light-transmissive. The material of the coating 45 may be, for example, polyethylene terephthalate that contains a light-shielding substance. The coating 45 has a functionality for limiting the light that enters the second core 41 of the second optical waveguide 40 from the second end surface 42.

### Method for Manufacturing Optical Module 15

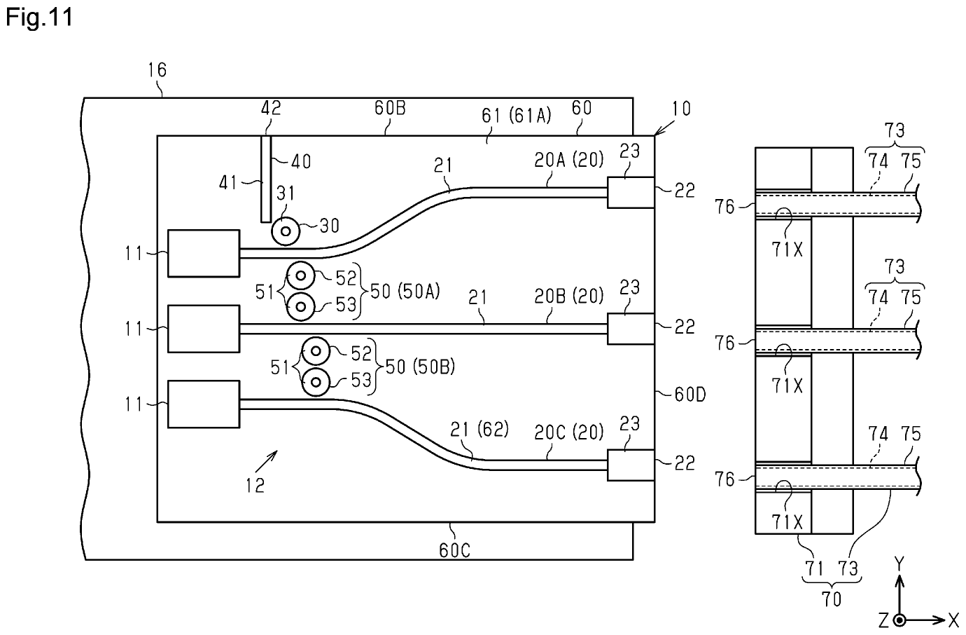

A method for manufacturing the optical module 15 will now be described with reference to FIGS. 11 to 16. FIGS. 11 to 16 do not illustrate the second cladding layer 61B of the silicon photonics element 10 and the cover 72 of the optical fiber array 70, in the same manner as FIG. 8.

In the step illustrated in FIG. 11, the silicon photonics element 10, which is mounted on the substrate 16, and the optical fiber array 70 are prepared. Then, the silicon photonics element 10 and the optical fiber array 70 are arranged separated from each other. For example, the silicon photonics element 10 and the optical fiber array 70 are positioned at desired locations, with the first end surface 22 of the silicon photonics element 10 facing the third end surface 76 of the optical fiber array 70. The silicon photonics element 10 of this step has the same structure as the silicon photonics element 10 illustrated in FIG. 2. In other words, the silicon photonics element 10 of this step does not include the melted portion 32 and the coating 45 illustrated in FIG. 8.

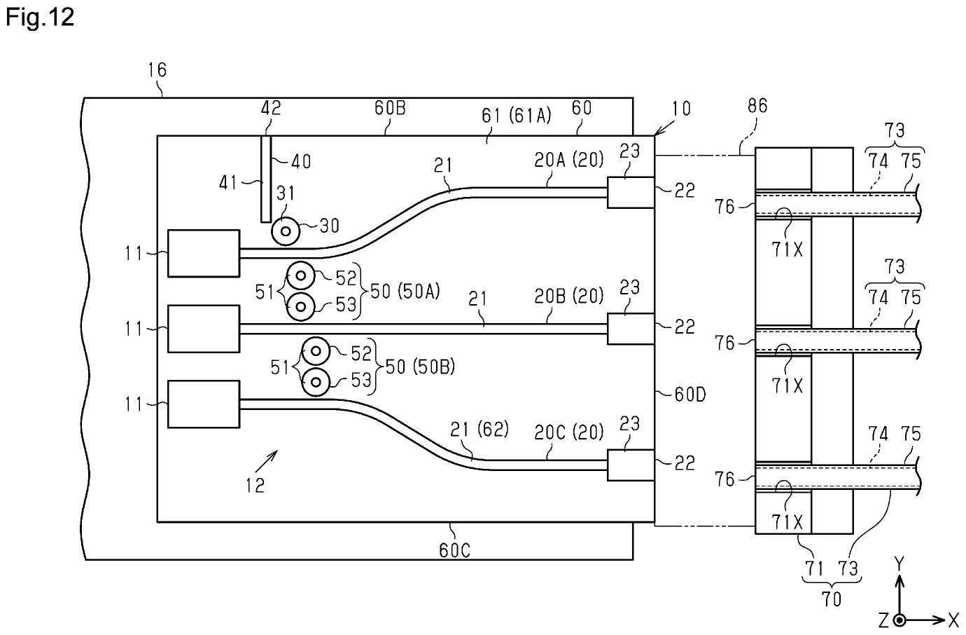

Then, in the step illustrated in FIG. 12, a photocuring resin 86 is formed between the silicon photonics element 10 and the optical fiber array 70. The photocuring resin 86 fills the gap between the silicon photonics element 10 and the optical fiber array 70. The photocuring resin 86 entirely covers the first end surface 22 of the first core 21 (edge coupling portion 23) of the first optical waveguide 20 and the third end surface 76 of the core 74 of the optical fibers 73. The photocuring resin 86 is a resin that transmits light when photocured. The photocuring resin 86 may be, for example, a solution obtained by adding a photopolymerization initiator to a monomer or an oligomer. Alternatively, the photocuring resin 86 may be, for example, a mixed liquid containing monomer A that will have a relatively high refractive index subsequent to photocuring and monomer B that will have a relatively low refractive index subsequent to photocuring. Monomer A may be, for example, a radical polymerization type acrylic monomer. Monomer B may be, for example, a cationic polymerization type epoxy-based monomer. For example, a given amount of a radical polymerization initiator that is sensitive to a specific first wavelength λ1 and a given amount of a cationic polymerization initiator that is not sensitive to the first wavelength λ1 are added to the mixed liquid of monomer A and monomer B. The radical polymerization initiator and the cationic polymerization initiator are, for example, sensitive to ultraviolet light.

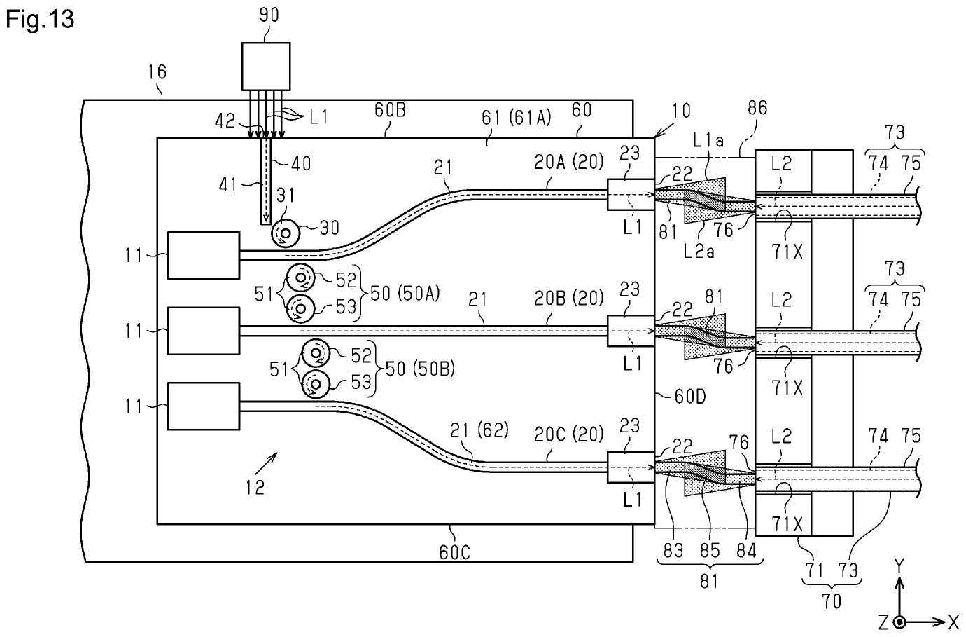

In the step illustrated in FIG. 13, light L1 having the first wavelength λ1 is emitted from the first end surface 22 of each first optical waveguide 20 toward the photocuring resin 86, and light L2 having the first wavelength λ1 is emitted from the third end surface 76 of each optical fiber 73 toward the photocuring resin 86. This selectively polymerizes and cures monomer A in the photocuring resin 86 and forms the core 81 extending from the first end surface 22 to the third end surface 76. The polymerization (curing) of monomer A starts from positions around the central portion of each first core 21 and the central portion of each core 74. The polymerization region grows so as to extend continuously and axially in the direction in which light travels. This forms the straight portion 83, which axially extends from the first end surface 22, and the straight portion 84, which axially extends from the third end surface 76. In this example, the center axis of the first core 21 is shifted away from the center axis of the core 74. Nevertheless, the emission light L1a emitted from the first end surface 22 of the first core 21 is superposed with the emission light L2a emitted from the third end surface 76 of the core 74 so that the light intensity increases at the superposed portion thereby bending and growing the core 81 in the direction in which the light intensity is high. This forms the bent portion 85 that connects the straight portion 83 and the straight portion 84. Consequently, the core 81 is formed, extending from the first end surface 22 of the first core 21 to the third end surface 76 of the core 74.

The method for emitting light L1 having the first wavelength λ1 from the first end surface 22 of each first core 21 in the step of FIG. 13 will now be described.

The optical elements 11 of the silicon photonics element 10 are light-receiving elements that are not self-luminescent. Thus, light having the first wavelength λ1 cannot be emitted from the optical elements 11. To emit light L1 having the first wavelength λ1 from the first end surface 22 of each first core 21, the silicon photonics element 10 includes the ring resonator 30, the second optical waveguide 40, and the double-ring resonators 50 (ring resonators 52 and 53). The diameter of the ring resonators 30, 52, and 53, the composition of the photocuring resin 86, and the like are set so that the resonant wavelength λr of the ring resonators 30, 52, and 53 (refer to FIG. 5) becomes equal to the first wavelength λ1. In this step, a light source 90 is arranged in the vicinity of the second end surface 42 of the second optical waveguide 40, and light L1 having the first wavelength λ1 is emitted from the light source 90 toward the second end surface 42 of the second optical waveguide 40. The light source 90 may be, for example, a laser light source or a collimated light source. Here, the light source 90 is a collimated light source. When using a collimated light source as the light source 90, the light source 90 will emit collimated light. Thus, the light source 90 and the second optical waveguide 40 do not have to be accurately positioned.

When light L1 having the first wavelength λ1, or the resonant wavelength λr of the ring resonators 30, 52, and 53, enters the second optical waveguide 40 from the second end surface 42, the propagation path of light in the optical waveguide circuitry 12 will be as illustrated in FIG. 6. This will now be briefly described. Light L1 emitted from the light source 90 enters the second core 41 of the second optical waveguide 40 from the second end surface 42. When the light L1, which has the first wavelength λ1 (i.e., resonant wavelength λr of ring resonators 30, 52, and 53), propagates through the second optical waveguide 40, the ring resonator 30 and the double-ring resonators 50 propagate the light L1 to the three first optical waveguides 20A, 20B, and 20C. The light L1 propagated to each of the first optical waveguides 20A, 20B, and 20C is further propagated in the longitudinal direction of the first core 21 toward the first end surface 22 and emitted from the first end surface 22 toward the photocuring resin 86 as the emission light L1a. Thus, even if the optical elements 11, connected to the first optical waveguides 20, are light-receiving elements that are not self-luminescent, light L1 having the first wavelength λ1 is emitted from the first end surface 22 of each first optical waveguide 20 toward the photocuring resin 86. This forms the core 81 that optically connects the first optical waveguides 20 to the corresponding optical fibers 73.

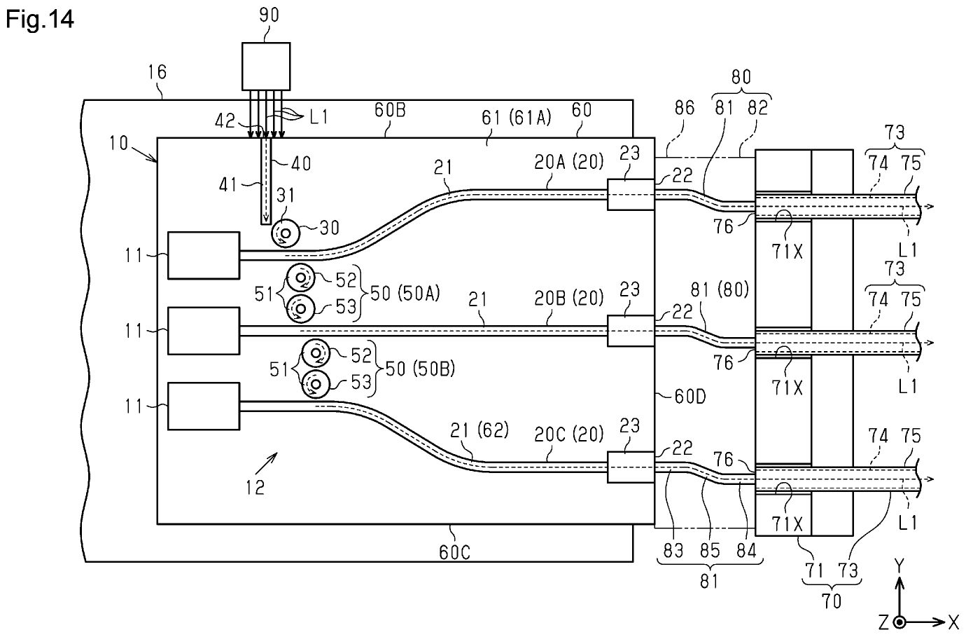

In the step illustrated in FIG. 14, the cladding 82 encompassing the core 81 is formed, and the self-written optical waveguide 80 including the core 81 and the cladding 82 is formed. For example, after the core 81 is formed, the photocuring resin 86 is irradiated with ultraviolet light to form the cladding 82. For example, the irradiation of the photocuring resin 86 with ultraviolet light polymerizes and cures monomer A and monomer B, which are sensitive to ultraviolet light, in the photocuring resin 86. This forms the cladding 82.

Then, the self-written optical waveguides 80 (core 81) are checked to determine whether they have been properly formed. For example, as illustrated in FIG. 14, among the first end surface 22 and the third end surface 76, light is emitted from only the first end surface 22 to check whether the light is emitted from the end surface (hereafter referred to as the opposite end surface) of the corresponding optical fibers 73 that is opposite the third end surface 76. When each self-written optical waveguide 80, which optically connects the corresponding first optical waveguide 20 and the corresponding optical fiber 73, is formed properly, the light emitted from only the first end surface 22 will be emitted from the opposite end surface of the optical fiber 73. In this manner, proper formation of the self-written optical waveguide 80 (core 81) is checked easily by checking whether light is emitted from the opposite end surface of the optical fiber 73. The method for emitting light from the first end surface 22 may be performed in the same manner as the step illustrated in FIG. 13. That is, light L1 having the first wavelength λ1 is emitted from the light source 90 and propagated through the second optical waveguide 40 and the ring resonators 30, 52, and 53 to the three first optical waveguides 20 in order to emit the light L1 from the first end surface 22 of each of the three first optical waveguides 20.

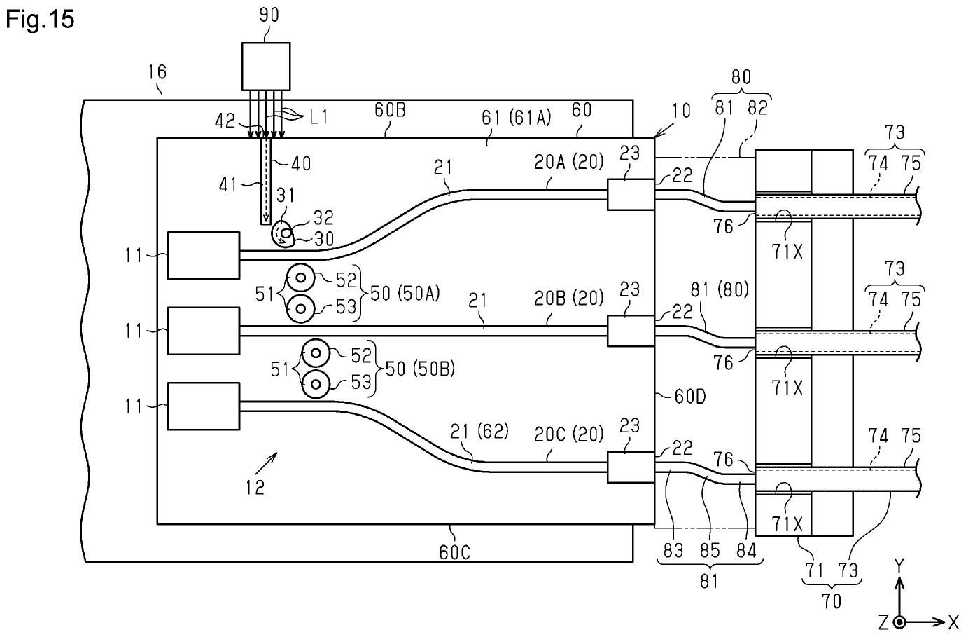

In the step illustrated in FIG. 15, after formation of the self-written optical waveguides 80 is checked, the ring resonator 30 is destructed. For example, the ring resonator 30 is destructed to eliminate the functionality for propagating light between the first optical waveguide 20A and the second optical waveguide 40. For example, the intensity of the light L1 emitted from the light source 90 is increased to accumulate excess energy in the ring resonator 30 and destruct the ring resonator 30. For example, the accumulation of excess energy in the ring resonator 30 heats and partially melts the ring core 31 of the ring resonator 30. This heats and melts part of the ring core 31 in the circumferential direction thereby forming the melted portion 32. The melted portion 32 deforms the ring structure of the ring core 31 and destructs the ring resonator 30. When the ring resonator 30 is destructed, light L1 is no longer be propagated from the ring resonator 30 to the first optical waveguides 20. Thus, the light L1 will not be emitted from the first end surface 22 of each first optical waveguide 20 and from the opposite end surface of each optical fiber 73. Accordingly, in this step, the light intensity of the light L1 emitted from the light source 90 is increased until the light L1 is no longer emitted from the first end surface 22 of each first optical waveguide 20 and the opposite end surface of each optical fiber 73.

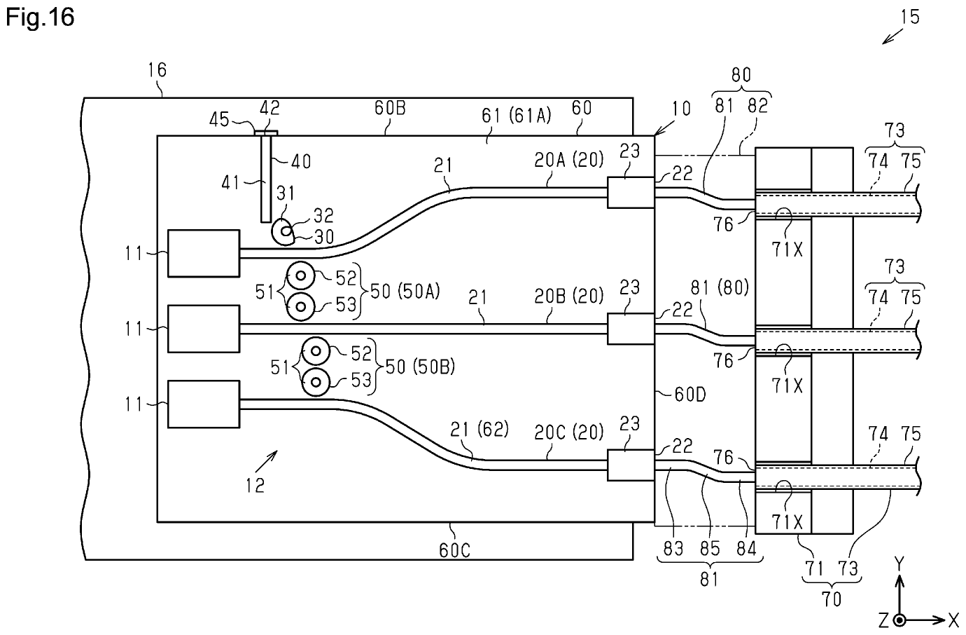

In the step illustrated in FIG. 16, the coating 45 is formed to cover the second end surface 42 of the second core 41 of the second optical waveguide 40. The coating 45 entirely covers the second end surface 42. The coating 45 is formed by, for example, applying resin that is not light-transmissive. The optical module 15 illustrated in FIG. 8 is manufactured through the above-described steps.

The silicon photonics element 10 of the above embodiment has the advantages described below.

(1) The silicon photonics element 10 includes the optical elements 11, which have no self-luminescent capability, and the first optical waveguides 20, which connect the optical elements 11 to the outside of the silicon photonics element 10. The silicon photonics element 10 includes the ring resonator 30, which is located proximate to one of the first optical waveguides 20 and optically connected to that first optical waveguide 20. The silicon photonics element 10 includes the second optical waveguide 40, which is located proximate to the ring resonator 30 and optically connected to the ring resonator 30. Each first optical waveguide 20 includes the first end surface 22, which is connected to the outside of the silicon photonics element 10. The second optical waveguide 40 includes the second end surface 42, which is connected to the outside of the silicon photonics element 10. The ring resonator 30 and the second optical waveguide 40 allows the light L1 that enters the second end surface 42 of the second optical waveguide 40 to be emitted from the first end surface 22 of each first optical waveguide 20 out of the silicon photonics element 10. That is, when light L1 having the resonant wavelength λr of the ring resonator 30 enters the second optical waveguide 40 from the second end surface 42, the light L1 is propagated to the ring resonator 30. Then, the light L1, propagated to the ring resonator 30, is further propagated to each first optical waveguide 20. The light L1 is propagated through the first optical waveguide 20 toward the first end surface 22 and then emitted from the first end surface 22. In this manner, even though the optical elements 11, which are connected to the first optical waveguides 20, are not self-luminescent, light L1 is emitted from the first end surface 22 of each first optical waveguide 20, which is connected to the outside of the silicon photonics element 10. Thus, the self-written optical waveguides 80, which optically connects the first optical waveguides 20 and the optical fibers 73, is readily formed by using the light L1 emitted from the first end surface 22 of each first optical waveguide 20. This facilitates optical connection of the first optical waveguides 20 and the optical fibers 73. Consequently, the optical connection of the silicon photonics element 10 and the optical fibers 73 is improved.

(2) The second optical waveguide 40 extends in a direction intersecting the longitudinal direction of the first optical waveguides 20. The ring resonator 30 is located proximate to the longitudinally middle portion of the first optical waveguide 20. The second optical waveguide 40 is located proximate to the edge portion of the ring resonator 30 that is closest to the optical elements 11. With this structure, when light L1 having the resonant wavelength λr of the ring resonator 30 enters the second optical waveguide 40 from the second end surface 42, the light L1 is propagated by the ring resonator 30 to one of the first optical waveguides 20 in order to emit the light L1 from the first end surface 22 in a preferred manner.

(3) The silicon photonics element 10 includes the optical elements 11 and the first optical waveguides 20, which are connected to the optical elements 11. The first optical waveguides 20 are arranged, spaced apart from one another in the first direction (Y-axis direction) that intersects the longitudinal direction of the first optical waveguides 20. The double-ring resonators 50 are located between two adjacent ones of the first optical waveguides 20 in the first direction. The ring resonator 30, the second optical waveguide 40, and the double-ring resonator 50 allow the light L1 that enters the second end surface 42 of the second optical waveguide 40 to be emitted from the first end surface 22 of each of the first optical waveguides 20. More specifically, the light propagated from the second optical waveguide 40 through the ring resonator 30 to the first optical waveguide 20A is further propagated to the double-ring resonators 50. The light L1 propagated to the double-ring resonators 50 is sequentially propagated to the first optical waveguides 20B and 20C. The light L1 propagated through each of the first optical waveguides 20B and 20C is propagated toward the corresponding first end surface 22. The light L1 is then emitted from the first end surface 22 of each of the first optical waveguides 20B and 20C. In this manner, even though there are multiple first optical waveguides 20, light L1 is emitted from the first end surface 22 of each of the first optical waveguides 20. Thus, the self-written optical waveguides 80, which optically connect the first optical waveguides 20 and the optical fibers 73, is readily formed by using the light L1 emitted from the first end surfaces 22.

Further, the light L1 propagated from the second optical waveguide 40 through the ring resonator 30 to the first optical waveguide 20A is propagated by the double-ring resonators 50 to the first optical waveguides 20B and 20C. This allows the light L1, which enters the single second optical waveguide 40, to be emitted from the first end surface 22 of each of the multiple first optical waveguides 20A, 20B, and 20C. Thus, only one light source 90 is used to send the light L1 into the second optical waveguide 40. This facilitates positioning of the light source 90 and the second optical waveguide 40.

(4) The resonant wavelength λr of the ring resonator 30 is set to a wavelength that differs from wavelength λc, which is used for optical communication by the optical elements 11. This avoids situations in which optical signals having wavelength λc are propagated through the ring resonator 30 to the second optical waveguide 40 when optical communication is actually performed between the optical elements 11 and the optical fibers 73. As a result, during optical communication that is actually performed between the optical elements 11 and the optical fibers 73, the arrangement of the ring resonator 30 will not cause undesirable effects such as transmission loss.

(5) The ring resonator 30 of the optical module 15 is at least partially melted. The ring resonator 30 is destructed in the optical module 15 after the self-written optical waveguides 80 are formed, that is, after the ring resonator 30 becomes unnecessary. This avoids situations in which optical signals are propagated from the optical fibers 73 toward the optical elements 11 are further propagated through the ring resonator 30 to the second optical waveguide 40 when optical communication is actually performed between the optical elements 11 and the optical fibers 73. As a result, during optical communication that is actually performed between the optical elements 11 and the optical fibers 73, the arrangement of the ring resonator 30 will not cause undesirable effects such as transmission loss.

(6) The optical module 15 includes the coating 45 that entirely covers the second end surface 42 of the second optical waveguide 40. The coating 45 is formed from a resin that is not light-transmissive. The coating 45 entirely covers the second end surface 42 in the optical module 15 after the self-written optical waveguide 80 is formed, that is, after the second optical waveguide 40 becomes unnecessary. Thus, unnecessary light will not enter the second optical waveguide 40 from the second end surface 42 when optical communication is actually performed between the optical elements 11 and the optical fibers 73.

(7) Proper formation of the self-written optical waveguides 80, which optically connect the first optical waveguides 20 and the optical fibers 73, may be checked through, for example, the following method. Optical signals from the optical fibers 73 are propagated through the self-written optical waveguides 80 and the first optical waveguides 20 toward the optical elements 11. The optical elements 11 then photoelectrically convert the optical signals to electric signals that are detected to check whether the self-written optical waveguides 80 have been formed. This method will, however, require a probe to detect the electrical signals generated by the optical elements 11.

In contrast, in the present embodiment, among the first end surface 22 and the third end surface 76, light is emitted from only the first end surface 22. By checking whether the light is emitted from the opposite end surface of the corresponding optical fiber 73, formation of the corresponding self-written optical waveguide 80 is checked. This method allows formation of the self-written optical waveguides 80 to be checked by using the light source 90, which is also used to form the self-written optical waveguides 80. Thus, formation of the self-written optical waveguide 80 is checked more easily than the method that detects the electrical signals generated by the optical elements 11.

### Other Embodiments

It should be apparent to those skilled in the art that the foregoing embodiments may be implemented in many other specific forms without departing from the scope of this disclosure. Particularly, it should be understood that the foregoing embodiments may be implemented in the following forms.

The above embodiment and the modified examples described below may be combined as long as there is no technical contradiction.

In each first optical waveguide 20, the edge coupling portion 23 may be replaced by a spot-size converter, a rib waveguide, or a silicon wire waveguide.

The edge coupling portion 23 may be omitted from each first optical waveguide 20 in the above embodiment.

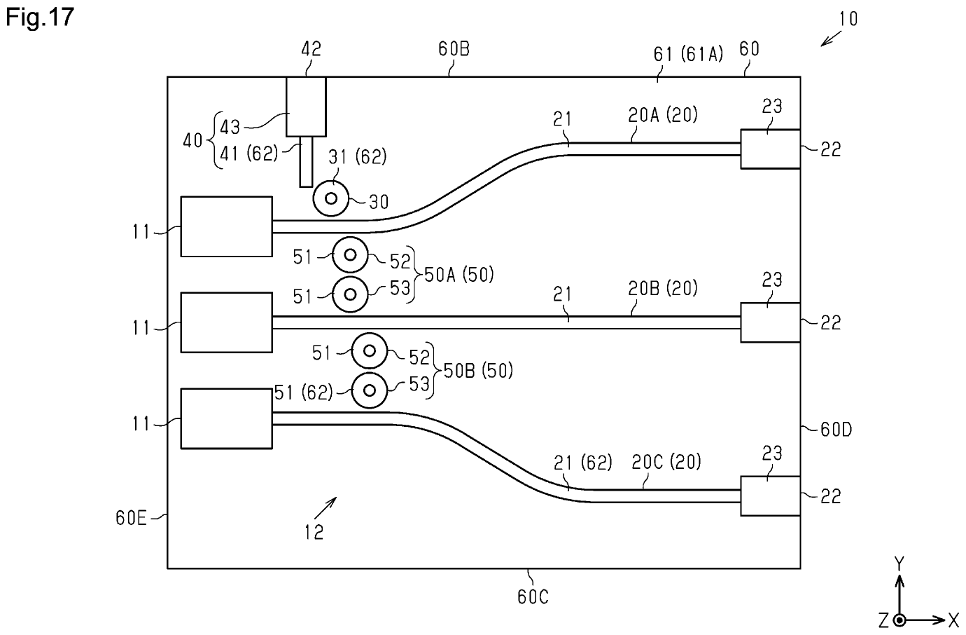

As illustrated in FIG. 17, one end of the second core 41 of the second optical waveguide 40 may include an edge coupling portion 43. The edge coupling portion 43 is arranged on the one of the two longitudinal ends of the second core 41 that is connected to the outside of the silicon photonics element 10. The edge coupling portion 43 has, for example, a structure similar to that of the edge coupling portion 23. The edge coupling portion 43 is, for example, larger than other parts of the second core 41.

The edge coupling portion 43 of the modified example illustrated in FIG. 17 may be replaced by a spot-size converter or a rib waveguide.

The silicon photonics element 10 includes one second optical waveguide 40. However, the second optical waveguide 40 is not particularly limited in number. For example, the silicon photonics element 10 may include two or more second optical waveguides 40. In this case, the ring resonator 30 is arranged proximate to the end of each the second optical waveguide 40. For example, when forming the self-written optical waveguide 80, the light source 90 is arranged in the vicinity of each of the second optical waveguides 40 so that each second optical waveguide 40 receives light L1 from the light source 90.

When three second optical waveguides 40 are arranged in correspondence with the three first optical waveguides 20, and a second optical waveguide 40 and a ring resonator 30 are arranged in correspondence with each of the three first optical waveguide 20, the double-ring resonator 50 may be omitted.

In the optical module 15 of the above embodiment, the melted portion 32 of the ring core 31 may be omitted.

In the optical module 15 of the above embodiment, the coating 45 may be omitted.

In the above embodiment, the cladding 82 of the self-written optical waveguide 80 is formed by irradiating the photocuring resin 86 with ultraviolet light. However, the cladding 82 does not have to be formed in such a manner. For example, after forming the core 81, unreacted portions of the photocuring resin 86 may be removed to form the cladding 82 with a photocuring resin having a refractive index differing from that of the photocuring resin 86. Further, after forming the core 81, unreacted portions of the photocuring resin 86 may be removed to form the cladding 82 with an air layer.

The method for manufacturing the optical module 15 of the above embodiment does not have to include the step of checking whether the self-written optical waveguides 80 have been properly formed.

The composition of the photocuring resin 86 in the above embodiment may be changed.

In the optical module 15, the silicon photonics element 10 and the optical fiber array 70 do not have to be arranged so that the center axis of each edge coupling portion 23 is shifted away from the center axis of the core 74 of the corresponding optical fiber 73. For example, the silicon photonics element 10 and the optical fiber array 70 may be arranged so that the center axis of each edge coupling portion 23 is aligned with the center axis of the core 74 of the corresponding optical fiber 73.

The structure of the optical fiber array 70 in the above embodiment may be changed. For example, the structure of the V-groove substrate 71 and the cover 72 may be modified as long as the optical fibers 73 are fixed in a state arranged next to one another.

The optical component that performs optical communication with the optical elements 11 of the silicon photonics element 10 in the optical module 15 of the above embodiment does not have to be the optical fiber array 70. For example, an optical component other than the optical fiber array 70 may be used as the optical component as long as optical communication is performed with the optical elements 11. For example, an optical component including a light emitting element may be used.

The substrate 16 may be mounted together with the optical fiber array 70 and the silicon photonics element 10 on the optical module 15 of the above embodiment.

The silicon photonics element 10 of the above embodiment includes the three optical elements 11 and the three first optical waveguides 20 respectively connected to the three optical elements 11. However, the optical elements 11 and the first optical waveguides 20 mounted on the silicon photonics element 10 are not particularly limited in number. For example, two optical elements 11 and two first optical waveguides 20 may be arranged on the silicon photonics element 10. For example, four or more optical elements 11 and four or more first optical waveguides 20 may be arranged on the silicon photonics element 10.

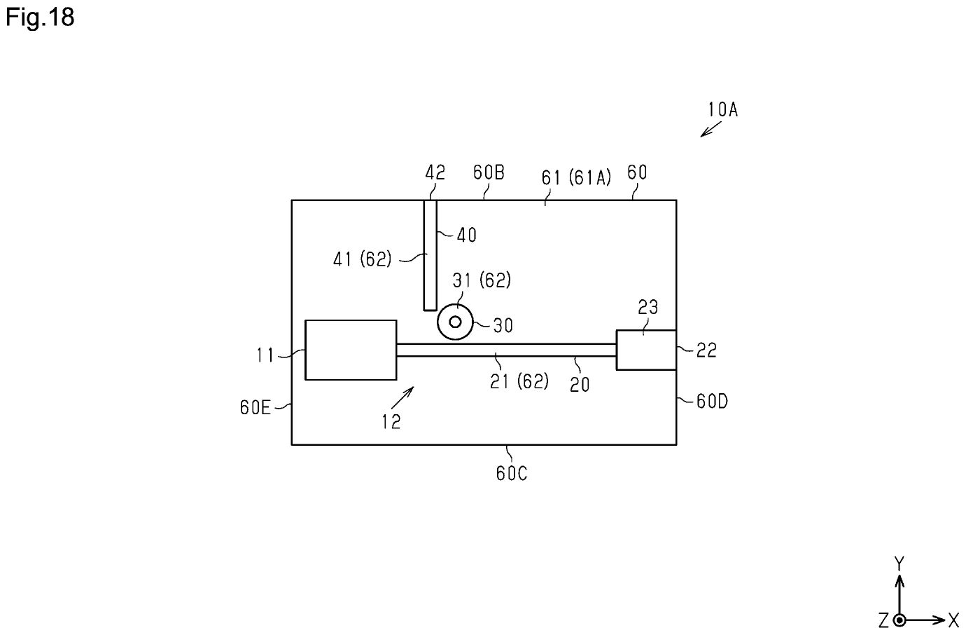

For example, as illustrated in FIG. 18, one optical element 11 and one first optical waveguide 20 may be arranged on a silicon photonics element 10A. The silicon photonics element 10A of this modified example includes the single optical element 11, the single first optical waveguide 20 connected to the single optical element 11, the ring resonator 30, and the second optical waveguide 40. The double-ring resonators 50 illustrated in FIG. 2 are omitted from the silicon photonics element 10A.

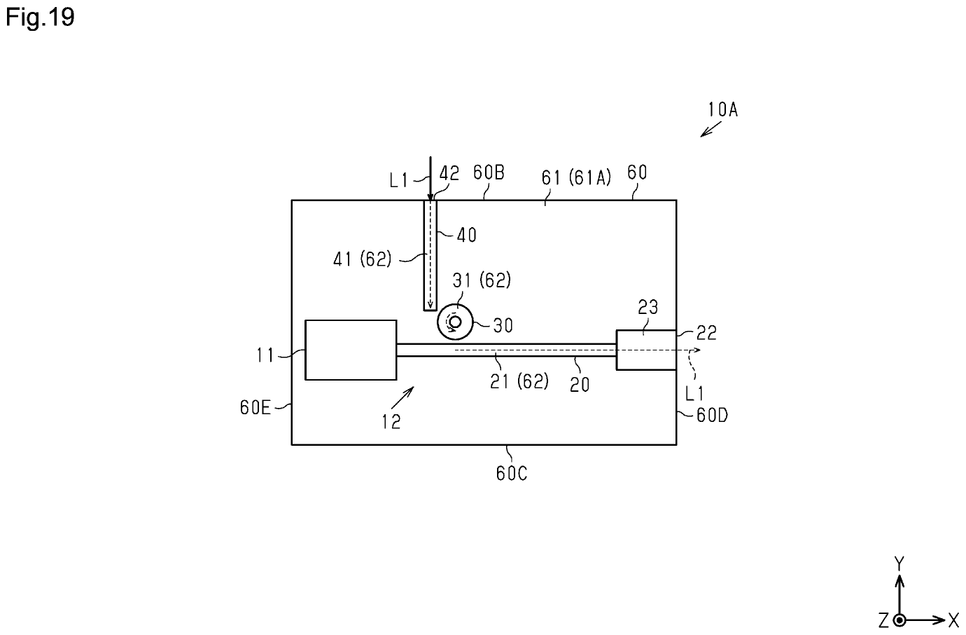

As illustrated in FIG. 19, in the silicon photonics element 10A, when light L1 having the resonant wavelength λr of the ring resonator 30 enters the second optical waveguide 40 from the second end surface 42, the light L1 is propagated to the ring resonator 30. The light L1 is propagated through the ring resonator 30 to the first optical waveguide 20. In the first optical waveguide 20, the light L1 is propagated from the ring resonator 30 toward the first end surface 22. This allows the light L1 to be emitted from the first end surface 22 of the first core 21 of the first optical waveguide 20.

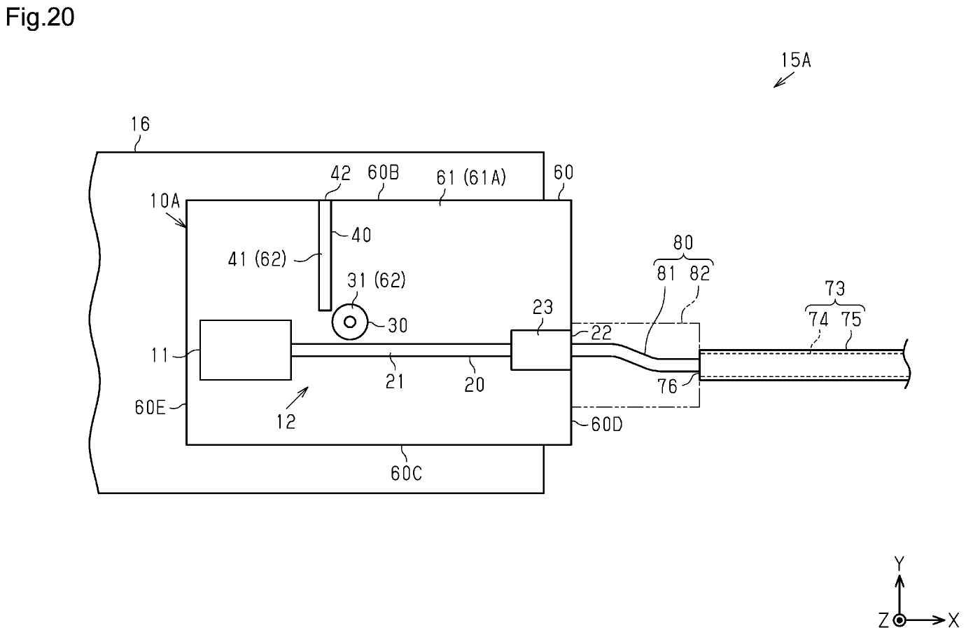

As illustrated in FIG. 20, for example, an optical module 15A may include the silicon photonics element 10A illustrated in FIG. 18. The optical module 15A of this modified example includes the substrate 16, the silicon photonics element 10A mounted on the substrate 16, the optical fiber 73, and the self-written optical waveguide 80 optically connecting the first optical waveguide 20 and the optical fiber 73. In the same manner as the above embodiment, the core 81 of the self-written optical waveguide 80 is formed by irradiating the photocuring resin 86 (refer to FIG. 13) with light L1 and light L2 that have the first wavelength λ1 from the first end surface 22 of the first optical waveguide 20 and the third end surface 76 of the optical fiber 73. Although not illustrated in the drawings, in the optical module 15A of FIG. 20, the ring resonator 30 may include the melted portion 32 (refer to FIGS. 7 and 8). That is, after the core 81 of the self-written optical waveguide 80 is formed, the ring resonator 30 may be at least partially melted.

The optical component that performs optical communication with the optical element 11 of the silicon photonics element 10 in the optical module 15A of FIG. 20 does not have to be the optical fiber 73. For example, an optical component other than the optical fiber 73 may be used as the optical component as long as optical communication is performed with the optical element 11. For example, an optical component including a light emitting element may be used.

Components other than the optical elements 11 and the optical waveguide circuitry 12 such as optional functional elements and electronic components may be mounted on the silicon photonics elements 10 and 10A of the above embodiment and the modified examples.

### CLAUSES

This disclosure further encompasses the following embodiments.
1. A method for manufacturing an optical module, the method including:
preparing a silicon photonics element in which the silicon photonics element includes an optical element that has no self-luminescent capability, a first optical waveguide optically connected to the optical element, a ring resonator optically connected to the first optical waveguide and located proximate to the first optical waveguide, and a second optical waveguide optically connected to the ring resonator and located proximate to the ring resonator;
preparing an optical component;
arranging the silicon photonics element and the optical component in a state separated from each other;
applying photocuring resin between the silicon photonics element and the optical component;
forming a self-written optical waveguide that optically connects the first optical waveguide and the optical component by emitting first light from the first optical waveguide toward the photocuring resin and by emitting second light from the optical component toward the photocuring resin, in which
the first optical waveguide includes a first end surface connected to outside of the silicon photonics element,
the second optical waveguide includes a second end surface connected to the outside of the silicon photonics element, and
the forming a self-written optical waveguide includes sending the first light into the second optical waveguide from the second end surface, propagating the first light through the ring resonator to the first optical waveguide, and emitting the first light from the first end surface.
2. The method according to clause 1, further including:
after the forming a self-written optical waveguide, melting at least part of the ring resonator with heat by increasing a light intensity of the first light that enters the second optical waveguide,
in which the melting at least part of the ring resonator with heat includes increasing the light intensity of the first light that enters the second optical waveguide until the first light is no longer emitted from the first end surface.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to an illustration of the superiority and inferiority of the invention. Although embodiments have been described in detail, it should be understood that various changes, substitutions, and alterations could be made hereto without departing from the scope of this disclosure.

1. A silicon photonics element, comprising:
an optical element that has no self-luminescent capability;
a first optical waveguide that connects the optical element to an outside of the silicon photonics element;
a ring resonator optically connected to the first optical waveguide and located proximate to the first optical waveguide; and
a second optical waveguide optically connected to the ring resonator and located proximate to the ring resonator, wherein
the first optical waveguide includes a first end surface connected to the outside of the silicon photonics element, and
the second optical waveguide includes a second end surface connected to the outside of the silicon photonics element.

2. The silicon photonics element according to claim 1, wherein the ring resonator is configured to propagate light to the first optical waveguide so that the light entering the second optical waveguide from the second end surface is emitted from the first end surface.

3. The silicon photonics element according to claim 1, wherein the ring resonator has a resonant wavelength set to a wavelength that differs from a wavelength used for optical communication of the optical element.

4. The silicon photonics element according to claim 1, wherein:
the optical element is one of a plurality of optical elements;
the first optical waveguide is one of a plurality of first optical waveguides, each of the first optical waveguides being connected to one of the optical elements;
the first optical waveguides are spaced apart from each other in a first direction that intersects a longitudinal direction of the first optical waveguides; and
the silicon photonics element further comprises a double-ring resonator located between two adjacent ones of the first optical waveguides in the first direction.

5. The silicon photonics element according to claim 1, wherein:
the second optical waveguide extends in a direction intersecting a longitudinal direction of the first optical waveguide;
the ring resonator is located proximate to a longitudinally middle potion of the first optical waveguide; and
the second optical waveguide is located proximate to an edge portion of the ring resonator that is closest to the optical element.

6. The silicon photonics element according to claim 1, wherein:
the first optical waveguide includes a first end connected to the optical element and a second end including the first end surface;
the second optical waveguide includes a first end located proximate to the ring resonator and a second end including the second end surface; and
the first end of the second optical waveguide is located between the ring resonator and the first end of the first optical waveguide.

7. An optical module, comprising:
a silicon photonics element;
an optical component separated from the silicon photonics element; and
a self-written optical waveguide located between the silicon photonics element and the optical component to optically connect the optical component and the silicon photonics element, wherein
the silicon photonics element includes:
an optical element that has no self-luminescent capability;
a first optical waveguide that optically connects the optical element and the self-written optical waveguide;
a ring resonator optically connectable to the first optical waveguide and located proximate to the first optical waveguide; and
a second optical waveguide optically connectable to the ring resonator and located proximate to the ring resonator,
the first optical waveguide includes a first end surface connected to the self-written optical waveguide, and
the second optical waveguide includes a second end surface connectable to an outside of the silicon photonics element.

8. The optical module according to claim 7, wherein the ring resonator has a structure in which at least part of the ring resonator is melted.

9. The optical module according to claim 7, further comprising:
a coating that entirely covers the second end surface,
wherein the coating is formed from a resin that is not light-transmissive.
